(19) United States
(12) Patent Application Publication
(10) Pub. No.: US 2026/0182720 A1
(43) Pub. Date: Jul. 2, 2026

(54) RAZOR BLADE CLEANING DEVICE

(71) Applicant: Tobias Detweiler, Cave City, KY (US)

(72) Inventor: Tobias Detweiler, Cave City, KY (US)

(21) Appl. No.: 19/004,884

(22) Filed: Dec. 30, 2024

(51) Int. Cl. A45D 27/46; F16B 47/00

(52) U.S. Cl. CPC A45D 27/46; F16B 47/00

(57) ABSTRACT

A razor blade cleaning device attachable to a wall and configured to clean a razor blade, the razor blade cleaning device including a main body, including a back portion coupled to the second side of the suction cup at a first surface thereof, the back portion including a plurality of back portion drainage apertures disposed within the back portion, such that the back portion drainage apertures extend from the first surface of the back portion, through an inner portion of the back portion, and through a second surface of the back portion opposite the first surface of the back portion, a razor contacting portion including a first surface to receive the razor blade thereon, a second surface to couple to the second surface of the back portion, and a plurality of razor contacting portion drainage apertures disposed within the razor contacting portion.

### BACKGROUND

### 1. Field

The present general inventive concept relates generally to a cleaning device, and particularly, to a razor blade cleaning device.

### 2. Description of the Related Art

For grooming and personal aesthetic preferences, the act of shaving is highly efficient in removing unwanted hair from various body locations such as the face, underarms, legs, etc.

However, post-shave, the task of effectively removing hair and debris from the razor blade used is challenging where often traditional methods like tapping the razor against the sink or using fingers to clean the blade, which can be inefficient, messy, and potentially dangerous.

Therefore, there is a need for device that helps a user clean a razor blade.

### SUMMARY

The present general inventive concept provides a razor blade cleaning device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a razor blade cleaning device attachable to a wall and configured to clean a razor blade, the razor blade cleaning device including at least one suction cup to attach to the wall at a first side of the suction cup, and a main body coupled at a back surface thereof to a second side of the suction cup to allow the main body to be attached to the wall, the main body including a back portion coupled to the second side of the suction cup at a first surface thereof, the back portion including a plurality of back portion drainage apertures disposed within the back portion, such that the back portion drainage apertures extend from the first surface of the back portion, through an inner portion of the back portion, and through a second surface of the back portion opposite the first surface of the back portion, a razor contacting portion including a first surface to receive the razor blade thereon, a second surface to couple to the second surface of the back portion, and a plurality of razor contacting portion drainage apertures disposed within the razor contacting portion, such that the razor contacting portion drainage apertures extend from the first surface of the razor contacting portion, through an inner portion of the razor contacting portion, and through the second surface of the razor contacting portion.

The plurality of razor contacting portion drainage apertures may be disposed to be in line with the plurality of back portion drainage apertures, so that water and hair may pass through the first surface of the razor contacting portion and out of the first surface of the back portion.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a front view of a razor blade cleaning device, according to an exemplary embodiment of the present general inventive concept; and

FIG. 2 illustrates a side view of the razor blade cleaning device of FIG. 1, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Razor Blade Cleaning Device 100
Main Body 110
Razor Contacting Portion 111
Razor Contacting Portion Drainage Apertures 111a
Back Portion 112
Back Portion Drainage Apertures 112a
Suction Cups 120

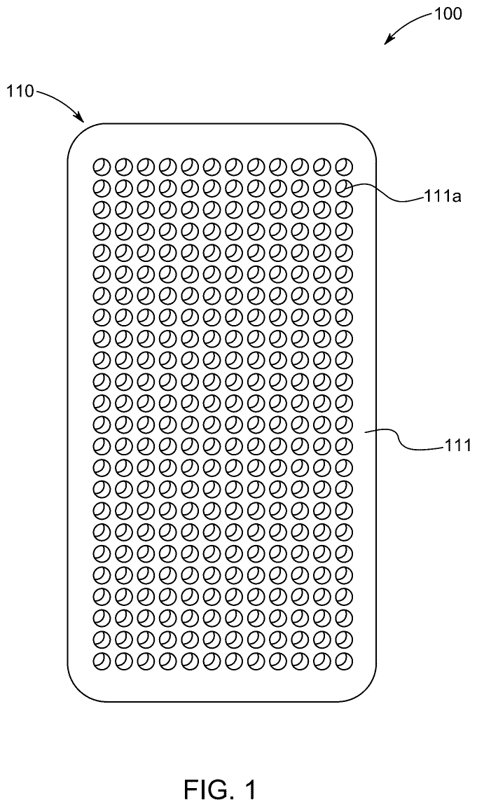

FIG. 1 illustrates a front view of a razor blade cleaning device 100, according to an exemplary embodiment of the present general inventive concept.

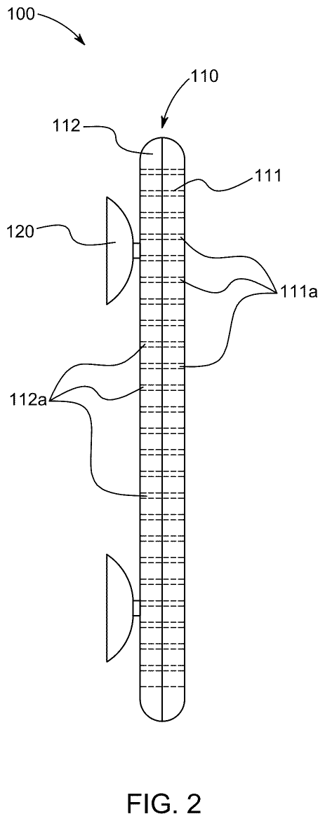

FIG. 2 illustrates a side view of the razor blade cleaning device 100 of FIG. 1, according to an exemplary embodiment of the present general inventive concept.

The razor blade cleaning device 100, and all components therein and/or connected thereto, may be constructed from at least one of metal, plastic, stone, ceramics, wood, silicone, liquid, gel, insulation material, glass, paper, cloth, circuitry, leather, memory foam, latex, and rubber, etc., but is not limited thereto, and can be constructed from any material known to one of ordinary skill in the art.

Referring to FIGS. 1 and 2, the razor blade cleaning device 100 may include a main body 110, and suction cups 120, but is not limited thereto.

The main body 110 may have any shape known to one of ordinary skill in the art.

The suction cups 120 may be disposed on a back portion of the main body 110, and may be designed to allow the razor blade cleaning device 100 to be attached to a bathroom wall or a shower wall and/or door via the suction cups 120.

The main body 110 may include a razor contacting portion 111 and a back portion 112, but is not limited thereto.

The razor contacting portion 111 may be disposed on a front portion of the main body 110 that face a user, and the back portion 112 may be disposed on a back portion of the main body that face a wall upon which the main body 110 is attached via the suction cups 110.

The back portion 112 may have the suction cups 120 disposed thereon to allow for easy wall attachment.

The razor contacting portion 111 may be made of a material, such as rubber or silicone (but is not limited thereto), which cleans a razor blade as the razor blade slides across the razor contacting portion.

The back portion 112 may be may of a material that is less elastic than the razor contacting portion 111, such as plastic or metal, but is not limited thereto.

The razor contacting portion 111 may be detachably coupled to the back portion 112, but is not limited thereto, and may be permanently coupled thereto.

The razor contacting portion 111 may include a plurality of razor contacting portion drainage apertures 111a, and the back portion 112 may include a plurality of back portion drainage apertures 112a.

The plurality of drainage apertures 111a may be disposed in a configuration to correspond directly to the plurality of back portion drainage apertures 112a, such that water and shaved hard can freely flow therethough from the razor contacting portion 111 to the back portion 112, such that the water and hair enters the plurality of drainage apertures 111a exits the back portion 112 through the plurality of back portion drainage apertures 112a.

Thus, as a user is showering and shaving, the user may rub his/her shaving razor across a front surface of the razor contacting portion 111 to clean the razor, and then may direct water from the shower onto the razor contacting portion 111 such that the water and the hair from the razor passes through the razor contacting portion drainage apertures 111a and then into the back portion drainage apertures 112a, so that the water and hair passes through a rear surface of the back portion 112.

The present general inventive concept may include a razor blade cleaning device 100 attachable to a wall and configured to clean a razor blade, the razor blade cleaning device 100 including at least one suction cup 120 to attach to the wall at a first side of the suction cup 120, and a main body 110 coupled at a back surface thereof to a second side of the suction cup 120 to allow the main body 110 to be attached to the wall, the main body 110 including a back portion 112 coupled to the second side of the suction cup 120 at a first surface thereof, the back portion 112 including a plurality of back portion drainage apertures 112a disposed within the back portion 112, such that the back portion drainage apertures 112a extend from the first surface of the back portion 112, through an inner portion of the back portion 112, and through a second surface of the back portion 112 opposite the first surface of the back portion 112, a razor contacting portion 111 including a first surface to receive the razor blade thereon, a second surface to couple to the second surface of the back portion 112, and a plurality of razor contacting portion drainage apertures 111a disposed within the razor contacting portion 111, such that the razor contacting portion drainage apertures 111a extend from the first surface of the razor contacting portion 111, through an inner portion of the razor contacting portion 111, and through the second surface of the razor contacting portion 111.

The plurality of razor contacting portion drainage apertures 111a may be disposed to be in line with the plurality of back portion drainage apertures 112a, so that water and hair may pass through the first surface of the razor contacting portion 111 and out of the first surface of the back portion 120.

A main purpose of the present general inventive concept is to enhance the efficiency and cleanliness of hand-held razors by providing a simple and effective method for removing hair and debris from the primary shaving accessory. Ingenious and practical, the present general inventive concept introduces a complimentary accessory for use with a razor that simplifies and expedites cleaning post-shave. Offering a compact, square design and strong adherence capabilities, the present general inventive concept permits users to stick it to smooth surfaces such as vanity mirrors or bathtub sides, making it readily accessible. As users shave, the cleaner is designed to be rubbed against the razor, ensuring that hair and residue are easily dislodged from the blades. This regular cleaning not only helps maintain the razor's performance but also prolongs its lifespan by preventing clogging and buildup that can degrade the quality of the blades used and thus the quality of personal results. The present general inventive concept further possesses a hard plastic backing with drainage holes which facilitates easy rinsing and drying, ensuring that the cleaner remains hygienic and effective with minimal effort. By integrating this tool into a standard shaving routine users can quickly dislodge hair from their razor with the ease of a swiping motion, thereby, enjoying an efficient and hassle-free experience with the added benefit of maintaining a cleaner and more organized grooming area. Overall, the present general inventive concept provides a practical solution to improve razor maintenance and to simplify the grooming routine for diverse consumers. As a result, the present general inventive concept may prove beneficial in the health/beauty novelty industry.

The present general inventive concept is unique due to its innovative design that combines functionality with convenience in a compact, user-friendly tool. Comprised of silicone or rubber materials formatted in a hand-held square design, this accessory effectively dislodges hair from razor blades with each swipe, enhancing the cleaning process during or after shaving. The present general inventive concept easily become a go-to tool for keeping razors clean and performing optimally, serving as a resource in private and commercial settings.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A razor blade cleaning device attachable to a wall and configured to clean a razor blade, the razor blade cleaning device comprising:
at least one suction cup to attach to the wall at a first side of the suction cup; and
a main body coupled at a back surface thereof to a second side of the suction cup to allow the main body to be attached to the wall, the main body comprising:
a back portion coupled to the second side of the suction cup at a first surface thereof, the back portion comprising a plurality of back portion drainage apertures disposed within the back portion, such that the back portion drainage apertures extend from the first surface of the back portion, through an inner portion of the back portion, and through a second surface of the back portion opposite the first surface of the back portion;
a razor contacting portion comprising a first surface to receive the razor blade thereon, a second surface to couple to the second surface of the back portion, and a plurality of razor contacting portion drainage apertures disposed within the razor contacting portion, such that the razor contacting portion drainage apertures extend from the first surface of the razor contacting portion, through an inner portion of the razor contacting portion, and through the second surface of the razor contacting portion.

2. The razor blade cleaning device, wherein the plurality of razor contacting portion drainage apertures are disposed to be in line with the plurality of back portion drainage apertures, so that water and hair may pass through the first surface of the razor contacting portion and out of the first surface of the back portion.
